(19) United States
(12) Patent Application Publication
(10) Pub. No.: US 2026/0209628 A1
(43) Pub. Date: Jul. 23, 2026

(54) MALEIC ACID-BASED ADDITIVE, GREASE COMPOSITION, AND ROLLING BEARING

(71) Applicants: JTEKT CORPORATION, Kariya-shi, Aichi (JP); DIC CORPORATION, Tokyo (JP)

(72) Inventors: Takeshi TSUDA, Kashiba-shi (JP); Kazunori MIYAKE, Kitakatsuragi-gun (JP); Masahiro KAJIKAWA, Takaishi-shi (JP); Yoshinobu KIMURA, Takaishi-shi (JP)

(73) Assignees: JTEKT CORPORATION, Kariya-shi, Aichi (JP); DIC CORPORATION, Tokyo (JP)

(21) Appl. No.: 19/137,945

(22) PCT Filed: Jan. 11, 2023
(86) PCT No.: PCT/JP2023/000494

§ 371 Date: Jun. 11, 2025

(51) Int. Cl. C10M 169/00; C10M 105/32; C10M 107/02; C10M 111/04; C10M 115/08; C10M 145/16; C10N 40/02; C10N 50/10; F16C 19/06; F16C 33/58; F16C 33/66

(52) U.S. Cl. CPC C10M 169/00; C10M 105/32; C10M 107/02; C10M 111/04; C10M 115/08; C10M 145/16; F16C 19/06; F16C 33/585; F16C 33/6607; C10M 2205/0206; C10M 2207/2805; C10M 2209/086; C10M 2215/1026; C10N 2040/02; C10N 2050/10

(57) ABSTRACT

A grease composition includes base oil, a thickener, and a maleic acid-based additive. The maleic acid-based additive is a polymer including maleic anhydride and either or both of an acrylic acid derivative and an olefin as monomer components. A content of the maleic acid-based additive is 0.10 mass % or more and 8.10 mass % or less with respect to a total mass of the thickener and the base oil.

### TECHNICAL FIELD

The present disclosure relates to a maleic acid-based additive, a grease composition, and a rolling bearing.

### BACKGROUND ART

In recent years, a demand for EVs has been increasing rapidly. Along with this increase in demand, requirements for rolling bearings for use in EVs are becoming more stringent. Specifically, there are such requirements that bearings can be applied to an increase in their rotation speed and an increase in heat generation along with a reduction in size and an increase in power of motors. That is, the rolling bearings for use in EVs etc. are required to be used under high temperature and high speed rotation conditions.

The rolling bearings for use under the high temperature and high speed rotation conditions (hereinafter also referred to as high temperature and high speed conditions) are filled with grease suitable for such use environment. Patent Document 1 proposes, as a grease composition having excellent high temperature and high speed durability, a grease composition that is obtained by blending an additive with base grease composed of base oil and a thickener and that uses a predetermined diurea compound as the thickener.

### RELATED ART DOCUMENTS

### Patent Documents

Patent Document 1: WO 2009/063839

### SUMMARY OF THE INVENTION

### Problem to be Solved by the Invention

When a rolling bearing filled with the grease composition described in Patent Document 1 is used under ultra-high speed conditions, the grease moves toward a seal of the rolling bearing due to a centrifugal force, and instantly enters a channeling state. Therefore, in the rolling bearing filled with the grease composition of Patent Document 1, it is difficult to supply the oil content between an inner ring and balls and between a cage and the balls, and the rolling bearing may undergo early seizure.

### Means for Solving the Problem

A grease composition of the present disclosure includes base oil, a thickener, and a maleic acid-based additive. The maleic acid-based additive is a polymer including maleic anhydride and either or both of an acrylic acid derivative and an olefin as monomer components. A content of the maleic acid-based additive is 0.10 mass % or more and 8.10 mass % or less with respect to a total mass of the thickener and the base oil.

A rolling bearing of the present disclosure includes rolling elements, a first raceway member, a second raceway member, and grease. The grease includes the grease composition of the present disclosure. The first raceway member includes a first raceway. The second raceway member includes a second raceway. The grease is interposed between the rolling elements and the first raceway and between the rolling elements and the second raceway, and adheres to at least one of a portion of the first raceway member adjacent to the first raceway and a portion of the second raceway member adjacent to the second raceway.

A maleic acid-based additive of the present disclosure is a maleic acid-based additive for use in a grease composition for a rolling bearing. The maleic acid-based additive includes a polymer including maleic anhydride and either or both of an acrylic acid derivative and an olefin as monomer components.

### Effects of the Invention

The grease composition of the present disclosure can improve the bearing lubrication life of the rolling bearing for use under high temperature and high speed conditions.

The rolling bearing of the present disclosure has a long bearing lubrication life. With the maleic acid-based additive of the present disclosure, the grease composition of the present disclosure can be provided.

### BRIEF DESCRIPTION OF THE DRAWINGS

FIG. 1 is a sectional view showing a ball bearing that is an example of a rolling bearing of the present disclosure.

FIGS. 2(a) and 2(b) are photographs showing the state of an evaluation sample after 120 hours in a bearing lubrication life evaluation test conducted using a grease composition of Example 1.

FIGS. 3(a) and 3(b) are photographs showing the state of an evaluation sample after 30 hours in a bearing lubrication life evaluation test conducted using a grease composition of Comparative Example 1.

FIG. 4 is a graph showing results of evaluation of the bearing lubrication life.

### MODES FOR CARRYING OUT THE INVENTION

### Overview of Embodiment of Invention of Present Disclosure

An overview of an embodiment of the invention of the present disclosure will be provided below.
(1) A grease composition according to one embodiment of the present disclosure includes base oil, a thickener, and a maleic acid-based additive. The maleic acid-based additive is a polymer including maleic anhydride and either or both of an acrylic acid derivative and an olefin as monomer components. A content of the maleic acid-based additive is 0.10 mass % or more and 8.10 mass % or less with respect to a total mass of the thickener and the base oil.
(2) In the grease composition according to (1), the content of the maleic acid-based additive is preferably 0.19 mass % or more and 7.50 mass % or less with respect to the total mass of the thickener and the base oil.
(3) In the grease composition according to (1), the content of the maleic acid-based additive is preferably 0.35 mass % or more and 6.20 mass % or less with respect to the total mass of the thickener and the base oil.
(4) In the grease composition according to (1), the content of the maleic acid-based additive is preferably 0.47 mass % or more and 5.00 mass % or less with respect to the total mass of the thickener and the base oil.
(5) In the grease composition according to any one of (1) to (4), a content of the thickener is preferably 10.0 mass % or more and 20.0 wt % or less with respect to the total mass of the base oil and the thickener.
(6) In the grease composition according to any one of (1) to (5), the thickener is preferably diurea.
(7) In the grease composition according to any one of (1) to (6), the base oil preferably includes at least one of poly-α-olefin oil, ester oil, and alkyldiphenyl ether oil.
(8) A rolling bearing according to one embodiment of the present disclosure includes rolling elements, a first raceway member, a second raceway member, and grease.

The grease includes the grease composition according to any one of (1) to (7). The first raceway member includes a first raceway. The second raceway member includes a second raceway. The grease is interposed between the rolling elements and the first raceway and between the rolling elements and the second raceway, and adheres to at least one of a portion of the first raceway member adjacent to the first raceway and a portion of the second raceway member adjacent to the second raceway.
(9) In the rolling bearing according to (8), it is preferable that the first raceway member be an inner ring and the second raceway member be an outer ring, or the first raceway member be a shaft washer and the second raceway member be a housing washer.
(10) It is preferable that the rolling bearing according to (8) or (9) further include at least one member out of a cage and a sealing device, and the grease adhere to the member.
(11) A maleic acid-based additive of the present disclosure is a maleic acid-based additive for use in a grease composition for a rolling bearing. The maleic acid-based additive includes a polymer including maleic anhydride and either or both of an acrylic acid derivative and an olefin as monomer components.

### Details of Embodiment of Invention of Present Disclosure

Hereinafter, the embodiment of the present disclosure will be described with reference to the drawings.

The rolling bearing according to the embodiment of the present disclosure is a ball bearing filled with the grease composed of the grease composition according to the embodiment of the present disclosure.

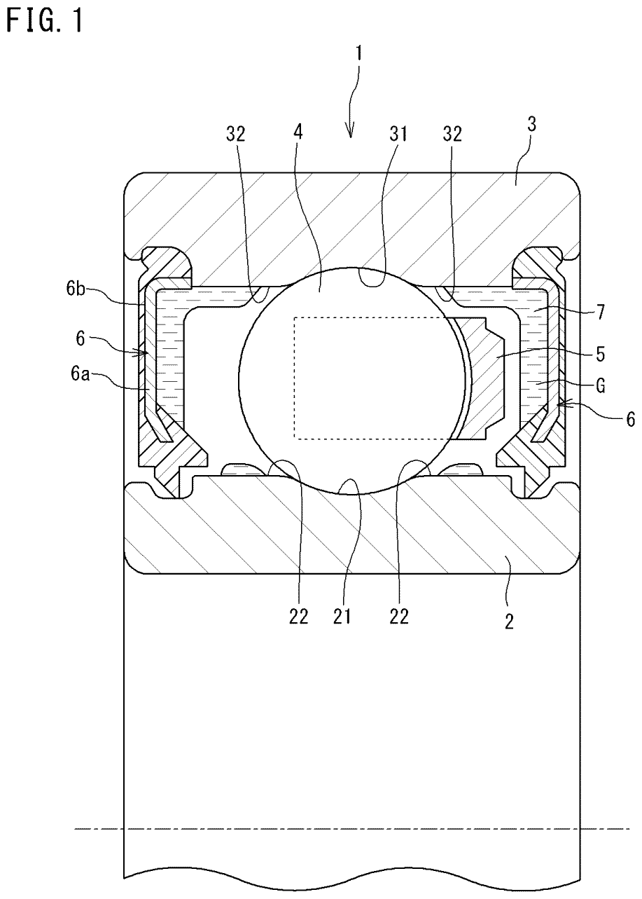

FIG. 1 is a sectional view showing a deep groove ball bearing according to one embodiment of the present disclosure.

A deep groove ball bearing 1 includes an inner ring 2, an outer ring 3 provided radially outward of the inner ring 2, a plurality of balls 4 serving as rolling elements provided between the inner ring 2 and the outer ring 3, and an annular cage 5 that holds the balls 4. In the deep groove ball bearing 1, the inner ring 2 corresponds to a first raceway member, and the outer ring 3 corresponds to a second raceway member.

The deep groove ball bearing 1 includes seals 6 serving as sealing devices on one axial side and the other axial side.

Further, an annular region 7 between the inner ring 2 and the outer ring 3 is filled with grease G composed of the grease composition according to the embodiment of the present disclosure.

The inner ring 2 has, on its outer periphery, an inner raceway surface 21 along which the balls 4 roll.

The outer ring 3 has, on its inner periphery, an outer raceway surface 31 along which the balls 4 roll.

The plurality of balls 4 is interposed between the inner raceway surface 21 and the outer raceway surface 31 and rolls along the inner raceway surface 21 and the outer raceway surface 31.

The inner raceway surface 21 of the deep groove ball bearing 1 corresponds to a first raceway, and the outer raceway surface 31 of the deep groove ball bearing 1 corresponds to a second raceway.

The grease G that fills the region 7 is present at contact points between the balls 4 and the inner raceway surface 21 of the inner ring 2 and at contact points between the balls 4 and the outer raceway surface 31 of the outer ring 3. The grease G also adheres to both portions (shoulders) 22 adjacent to the inner raceway surface 21 of the inner ring 2 and portions (shoulders) 32 adjacent to the outer raceway surface 31 of the outer ring 3. Further, the grease G adheres to the cage 5 and the seals 6. In some cases, the grease G adheres only to either of the portions (shoulders) 22 adjacent to the inner raceway surface 21 and the portions (shoulders) 32 adjacent to the outer raceway surface 31.

The grease G fills 20 to 40 vol % of the volume of a space surrounded by the inner ring 2, the outer ring 3, and the seals 6, excluding the balls 4 and the cage 5.

The seal 6 is an annular member including an annular metal ring 6a and an elastic member 6b fixed to the metal ring 6a. The radially outer portion is fixed to the outer ring 3 and the lip tip of the radially inner portion is attached so as to be slidable against the inner ring 2. The seal 6 prevents the filled grease G from leaking to the outside.

The grease G that fills the deep groove ball bearing 1 structured in this manner is the grease composed of the grease composition according to the embodiment of the present disclosure described later. Therefore, when the deep groove ball bearing 1 filled with the grease G is used under high temperature and high speed conditions, the grease G continues to be present at the contact points between the balls 4 and the inner raceway surface 21 of the inner ring 2, the contact points between the balls 4 and the outer raceway surface 31 of the outer ring 3, and the contact points between the balls 4 and the cage 5. Thus, when used under the high temperature and high speed conditions, the deep groove ball bearing 1 is less likely to seize, and the deep groove ball bearing 1 can be used for a long period of time.

Next, the grease composition constituting the grease G will be described in detail.

The grease composition is the grease composition according to the embodiment of the present disclosure, and contains base oil, a thickener, and a maleic acid-based additive. The grease G composed of the grease composition containing the maleic acid-based additive can easily maintain its adhesion to the raceway surface of the inner ring, the raceway surface of the outer ring, and the cage.

Examples of the base oil include poly-α-olefin (PAO), ester oil, polyalkylene glycol, fluorine oil, silicone oil, and ether oil such as alkyldiphenyl ether oil. These may be used alone or in combination of two or more kinds.

The base oil preferably includes at least one kind out of poly-α-olefin (PAO), ester oil, and alkyldiphenyl ether oil.

More preferably, the base oil is ether oil or mixed base oil of poly-α-olefin (PAO) and ester oil.

Examples of the poly-α-olefin include those obtained by oligomerizing or polymerizing α-olefins such as 1-hexene, 1-octene, 1-nonene, 1-decene, 1-dodecene, and 1-tetradecene, and those obtained by hydrogenating these.

The poly-α-olefin is preferably PAO4 to PAO8 (PAO4, PAO5, PAO6, PAO7, PAO8) obtained by oligomerizing 1-decene.

The base oil preferably has a base oil kinematic viscosity (40° C.) of 30 to 150 mm²/s. In this case, the grease G can easily maintain its adhesion to the raceway surface of the inner ring, the raceway surface of the outer ring, and the cage. Therefore, the rolling bearing filled with the grease G has a long bearing lubrication life. The torque of the rolling bearing filled with the grease G is less likely to be excessively large.

More preferably, the base oil kinematic viscosity (40° C.) is 30 to 50 mm²/s.

The base oil kinematic viscosity is a value conforming to JIS K 2283.

The thickener is not particularly limited, and is, for example, a urea-based thickener.

The urea-based thickener is preferably diurea.

The diurea is preferably diurea represented by the following structural formula (1).

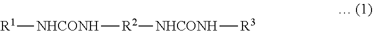

(In formula (1), R¹ and R³ are each independently a monovalent hydrocarbon group, and R² is —(CH₂)₆—, —C₆H₃(CH₃)—, or —C₆H₄—CH₂—C₆H₄—.)

When R² is —C₆H₃(CH₃)—, the phenylene group is preferably bonded in positions 2 and 4 or 2 and 6 with the methyl group in position 1. When R² is —C₆H₄—CH₂—C₆H₄—, both phenylene groups are preferably bonded in the para position.

R² is preferably —C₆H₄—CH₂—C₆H₄—.

In the diurea represented by the structural formula (1), the hydrocarbon group is an aliphatic hydrocarbon group, an aromatic hydrocarbon group, or an alicyclic hydrocarbon group.

The aliphatic hydrocarbon group is, for example, an aliphatic hydrocarbon group represented by —CₙH₂ₙ₊₁ (n is an integer of 6 to 20). The aliphatic hydrocarbon group may be linear or branched.

The aliphatic hydrocarbon group is preferably an octadecyl group (—C₁₈H₃₇).

The aromatic hydrocarbon group is, for example, an aromatic hydrocarbon group represented by R⁴—C₆H₄— (R⁴ is an alkyl group having 1 to 12 carbon atoms). The aromatic hydrocarbon group is preferably a p-tolyl group (p-methylphenyl group).

The alicyclic hydrocarbon group is, for example, an alicyclic hydrocarbon group represented by R⁵—C₆H₁₀— (R⁵ is hydrogen, a 2-methyl group, a 3-methyl group, or a 4-methyl group).

The alicyclic hydrocarbon group is preferably a cyclohexyl group (—C₆H₁₁).

When the thickener is composed of diurea, the thickener is composed of only one kind of diurea, or is composed of a mixture of a plurality of kinds of diurea having different chemical structures.

When the thickener is composed of a mixture of a plurality of kinds of diurea, the thickener is preferably a mixture A of diurea in which R¹ and R³ in the structural formula (1) are both octadecyl groups, diurea in which R¹ and R³ in the structural formula (1) are both cyclohexyl groups, and diurea in which one of R¹ and R³ in the structural formula (1) is an octadecyl group and the other is a cyclohexyl group.

The mixture A is preferably composed such that the octadecyl group is 50 to 70 mol %, the cyclohexyl group is 30 to 50 mol %, and the sum of the octadecyl group and the cyclohexyl group is 100 mol % with respect to the total of R¹ and R³.

The reason is as follows. Grease G composed of a grease composition in which the thickener is only diurea in which R¹ and R³ in the structural formula (1) are both octadecyl groups is softened under a high temperature atmosphere and is likely to leak from the bearing. The grease G in which the thickener is the mixture A is thermally cured under a high temperature atmosphere and is less likely to leak from the bearing.

Alternatively, the thickener is preferably a mixture B of diurea in which R¹ and R³ in the structural formula (1) are both p-tolyl groups, diurea in which R¹ and R³ in the structural formula (1) are both cyclohexyl groups, and diurea in which one of R¹ and R³ in the structural formula (1) is a p-tolyl group and the other is a cyclohexyl group.

The mixture B is preferably composed such that the p-tolyl group is 60 to 80 mol %, the cyclohexyl group is 20 to 40 mol %, and the sum of the p-tolyl group and the cyclohexyl group is 100 mol % with respect to the total of R¹ and R³.

The reason is as follows. The grease G in which the thickener is the mixture B is thermally cured under a high temperature atmosphere and is less likely to leak from the bearing.

The reason why the thickener composed of the mixture A or the mixture B is preferable is as follows. The rolling bearing filled with the grease G in which the thickener is the thickener composed of the mixture A or the mixture B has an excellent lubrication life under a high temperature atmosphere.

The base oil that is preferably combined with the mixture A is base oil obtained by mixing poly-α-olefin (PAO) and ester oil. The base oil that is preferably combined with the mixture B is ether oil.

The diurea represented by the structural formula (1) is a product obtained by a reaction of an amine compound with a diisocyanate compound.

The amine compound is an amine compound having functional groups corresponding to R¹ and R³ in the structural formula (1).

The amine compound is an aliphatic amine, an aromatic amine, or an alicyclic amine.

The aliphatic amine is an aliphatic amine having 6 to 20 carbon atoms. The aliphatic amine is preferably octadecylamine.

The aromatic amine is an aromatic amine represented by R⁴—C₆H₄—NH₃ (R⁴ is an alkyl group having 1 to 12 carbon atoms).

The aromatic amine is preferably p-toluidine (1-amino-4-methylbenzene).

The alicyclic amine is an alicyclic amine represented by R⁵—C₆H₁₀—NH₃ (R⁵ is hydrogen, a 2-methyl group, a 3-methyl group, or a 4-methyl group).

The aromatic amine is preferably cyclohexylamine.

Examples of the diisocyanate compound include hexamethylene diisocyanate (HDI), 2,4-toluene diisocyanate (2,4-TDI), 2,6-toluene diisocyanate (2,6-TDI), a mixture of 2,4-TDI and 2,6-TDI, and 4,4′-diphenylmethane diisocyanate (4,4′-MDI).

The diurea represented by the structural formula (1) can be obtained by a reaction of the amine compound with the diisocyanate compound under various conditions. The preferable reaction condition is that the reaction is performed in the base oil from the viewpoint of obtaining a diurea compound having high uniform dispersibility as the thickener. The reaction between the amine compound and the diisocyanate compound is performed by adding base oil in which the diisocyanate compound is dissolved to base oil in which the amine compound is dissolved, or by adding base oil in which the amine compound is dissolved to base oil in which the diisocyanate compound is dissolved.

The temperature and time conditions for the reaction between the aliphatic amine and the diisocyanate compound are not particularly limited. Conditions similar to those generally employed in this type of reaction can be employed.

The reaction temperature is preferably 150° C. to 170° C. from the viewpoints of the solubility and volatility of the amine compound and the diisocyanate compound.

The reaction time is preferably 0.5 to 2.0 hours from the viewpoints of completing the reaction between the amine compound and the diisocyanate compound and of shortening the production time and efficiently producing the grease composition.

The content of the thickener is preferably 10.0 mass % or more to 20.0 mass % with respect to the total mass of the base oil and the thickener. In this case, the rolling bearing filled with the grease G can easily supply the oil content of the grease G between the inner ring and the balls and between the cage and the balls. Further, the torque of the rolling bearing filled with the grease G is less likely to increase.

The maleic acid-based additive is a polymer including maleic anhydride and either or both of an acrylic acid derivative and an olefin as monomer components.

That is, the maleic acid-based additive is a copolymer of maleic anhydride and an acrylic acid derivative, a copolymer of maleic anhydride and an olefin, or a copolymer of maleic anhydride, an acrylic acid derivative, and an olefin.

The following products are available as the maleic acid-based additives. All of the following products are produced by DIC Corporation.
(1) PAD-19 (trade name): copolymer of maleic anhydride and acrylic acid derivative, weight average molecular weight: 67000, pale yellow clear liquid, dispersion (solid content: 24.0 to 26.0 mass %), viscosity: <500 mPa's, pH: 7.0 to 9.0, acid value: 460 (calculated value), glass transition point: 89° C., melting point: 143° C., thermal decomposition temperature: 326° C.
(2) PAD-21 (trade name): copolymer of maleic anhydride and acrylic acid derivative, weight average molecular weight: 27000, pale yellow clear liquid, dispersion (solid content: 24.0 to 26.0 mass %), viscosity: <300 mPa·s, pH: 7.0 to 9.0, acid value: 460 (calculated value), glass transition point: 39° C., melting point: 103° C., thermal decomposition temperature: 313° C.
(3) PAD-26 (trade name): copolymer of maleic anhydride and acrylic acid derivative, weight average molecular weight: 19000, pale yellow transparent liquid, dispersion (solid content: 24.0 to 26.0 mass %), viscosity: <100 mPa·s, pH: 7.0 to 9.0, acid value: 460 (calculated value), melting point: 52° C., thermal decomposition temperature: 358° C.
(4) PAD-30 (trade name): copolymer of maleic anhydride and acrylic acid derivative, weight average molecular weight: 10000, pale yellow transparent liquid, dispersion (solid content: 24.0 to 26.0 mass %), viscosity: <100 mPa·s, pH: 7.0 to 9.0, acid value: 460 (calculated value), melting point: 132° C., thermal decomposition temperature: 322° C.
(5) PAD-112 (trade name): copolymer of maleic anhydride and acrylic acid derivative, weight average molecular weight: 19000, pale yellow transparent liquid, dispersion (solid content: 24.0 to 26.0 mass %), viscosity: <100 mPa's, pH: 7.0 to 9.0, acid value: 610 (calculated value)

The content of the maleic acid-based additive is 0.10 mass % or more and 8.10 mass % or less with respect to the total amount of the base oil and the thickener.

In this case, the grease G composed of the grease composition containing the maleic acid-based additive can easily maintain its adhesion to the raceway surface of the inner ring, the raceway surface of the outer ring, and the cage. Therefore, the rolling bearing filled with the grease G has a long bearing lubrication life.

When the content of the maleic acid-based additive is less than 0.1 mass %, it is difficult for the grease G to maintain its adhesion to the raceway surface of the inner ring, the raceway surface of the outer ring, and the cage, and the grease G moves from the raceway surface of the inner ring, the raceway surface of the outer ring, and the cage to other parts (e.g., toward the seal) at an early stage. Therefore, the rolling bearing filled with the grease G does not have a long bearing lubrication life. When the content of the maleic acid-based additive exceeds 8.10 mass %, the running torque of the rolling bearing filled with the grease G is excessively large, which may cause poor rotation of the rolling bearing filled with the grease G.

The content of the maleic acid-based additive is preferably 0.19 mass % or more and 7.50 mass % or less with respect to the total amount of the base oil and the thickener from the viewpoint of extending the bearing lubrication life.

The content of the maleic acid-based additive is more preferably 0.35 mass % or more and 6.20 mass % or less with respect to the total amount of the base oil and the thickener from the viewpoint of further extending the bearing lubrication life.

The content of the maleic acid-based additive is still more preferably 0.47 mass % or more and 5.00 mass % or less with respect to the total amount of the base oil and the thickener from the viewpoint of even further extending the bearing lubrication life.

The grease composition may further contain a rust inhibitor and an antioxidant. In this case, the lubrication life of the grease composition can further be improved.

The grease composition may further contain other additives such as an extreme pressure agent, an oiliness agent, an antiwear agent, a dye, a color stabilizer, a thickening agent, a structural stabilizer, a metal deactivator, and a viscosity index improver.

Next, a method for producing the grease composition will be described. The grease composition can be produced, for example, by first preparing base grease composed of base oil and a thickener, then charging the maleic acid-based additive and other optional additives into the obtained base grease, and mixing the components by stirring with a planetary centrifugal mixer etc.

Therefore, the maleic acid-based additive is used for producing the grease composition according to the embodiment of the present disclosure.

According to the present embodiment, a grease composition containing the base oil and the thickener described above and a predetermined amount of the maleic acid-based additive is employed as the grease composition constituting the grease G that fills the deep groove ball bearing 1. By employing such a grease composition, the grease G of the deep groove ball bearing 1 filled with the grease G can easily maintain its adhesion to the inner ring, the outer ring, and the cage, and can ensure a sufficient bearing life when the deep groove ball bearing 1 is used under high temperature and high speed conditions.

The invention of the present disclosure is not limited to the above embodiment and may be implemented in other embodiments.

The ball bearing according to the embodiment of the present disclosure is not limited to the deep groove ball bearing, and may be an angular contact ball bearing or may be a thrust ball bearing including a shaft washer, a housing washer, balls, and a cage. In this case, the grease G is present at contact points between the balls and the raceway of the shaft washer and at contact points between the balls and the raceway of the housing washer. The grease G also adheres to the cage.

Further, the rolling bearing according to the embodiment of the present disclosure may be another rolling bearing such as a roller bearing that uses elements other than balls as rolling elements.

### EXAMPLES

Next, the invention of the present disclosure will be described in more detail based on examples, but the invention of the present disclosure is not limited to these examples.

As the examples, a plurality of grease compositions was prepared and the properties of the grease compositions were evaluated. The compositions and evaluation results of the grease compositions are shown in Table 1.

(Raw materials for Grease Compositions)
(1) Base Oil
(1-1) Poly-α-olefin oil (PAO8): base oil kinematic viscosity (40° C.)=47.5 mm²/s, base oil kinematic viscosity (100° C.)=7.8 mm²/s
(1-2) Ester oil: base oil kinematic viscosity (40° C.)=27 mm²/s, base oil kinematic viscosity (100° C.)=6 mm²/s
(1-3) Ether oil: base oil kinematic viscosity (40° C.)=100 mm²/s, base oil kinematic viscosity (100° C.)=13 mm²/s
(2) Thickener: diurea (reaction product of amine compound and diisocyanate compound)
(2-1) Amine compound
Aliphatic amine: octadecylamine
Alicyclic amine: cyclohexylamine
Aromatic amine: p-toluidine
(2-2) Diisocyanate
4,4′-diphenylmethane diisocyanate (4,4′-MDI)
(3) Additive
Maleic acid-based additive: PAD-26 (produced by DIC Corporation)

### (Preparation of Base Grease A)

(1) 4,4′-MDI, octadecylamine, and cyclohexylamine were measured such that octadecylamine was 60 mol % and cyclohexylamine was 40 mol % with respect to 50 mol % of 4,4′-MDI.
(2) The base oil in a half of the amount at which the blending amount is 85 mass % with respect to the total amount of base grease A (total amount of base oil and thickener) and 4,4′-MDI in an amount at which the blending amount of the thickener after reaction is 15 mass % with respect to the total amount of the base grease A are charged into a stainless steel container A and dissolved by heating to 60° C.
(3) The remaining base oil in a half of the amount at which the blending amount is 85 mass % with respect to the total amount of the base grease A and octadecylamine and cyclohexylamine in an amount at which the blending amount of the thickener after reaction is 15 mass % with respect to the total amount of the base grease A are charged into another stainless steel container B and dissolved by heating to 80° C.
(4) The amine mixture solution in the stainless steel container B is charged into the isocyanate solution by dripping it into the stainless steel container A.
(5) After confirming that the total amount of the amine mixture solution in the stainless steel container B has been charged into the stainless steel container A, the temperature of the solution of the isocyanate and the amine mixture is increased to 150° C.
(6) The solution of the isocyanate and the amine mixture is stirred while being heated and the temperature is maintained at 150° C. for 30 minutes.
(7) The heating of the solution of the isocyanate and the amine mixture is stopped and the solution is cooled in still air to room temperature. Thus, the base grease A is completed.

### (Preparation of Base Grease B)

(1) 4,4′-MDI, p-toluidine, and cyclohexylamine were measured such that p-toluidine was 30 mol % and cyclohexylamine was 70 mol % with respect to 50 mol % of 4,4′-MDI.
(2) The base oil in a half of the amount at which the blending amount is 85 mass % with respect to the total amount of base grease B (total amount of base oil and thickener) and 4,4′-MIDI in an amount at which the blending amount of the thickener after reaction is 15 mass % with respect to the total amount of the base grease B are charged into a stainless steel container A and dissolved by heating to 60° C.
(3) The remaining base oil in a half of the amount at which the blending amount is 85 mass % with respect to the total amount of the base grease B and p-toluidine and cyclohexylamine in an amount at which the blending amount of the thickener after reaction is 15 mass % with respect to the total amount of the base grease B are charged into another stainless steel container B and dissolved by heating to 80° C.
(4) The amine mixture solution in the stainless steel container B is charged into the isocyanate solution by dripping it into the stainless steel container A.
(5) After confirming that the total amount of the amine mixture solution in the stainless steel container B has been charged into the stainless steel container A, the temperature of the solution of the isocyanate and the amine mixture is increased to 150° C.
(6) The solution of the isocyanate and the amine mixture is stirred while being heated and the temperature is maintained at 150° C. for 30 minutes.
(7) The heating of the solution of the isocyanate and the amine mixture is stopped and the solution is cooled in still air to room temperature. Thus, the base grease B is completed.

### Example 1

The maleic acid-based additive was added at 5 parts by mass to 100 parts by mass of the base grease A. The base grease A to which the maleic acid-based additive had been added was mixed using a planetary centrifugal mixer under conditions that the rotation speed was 2000 rpm and the time was 3 minutes, and then homogenized using a triple roll mill to obtain a grease composition.

### Example 2

The maleic acid-based additive was added at 1 part by mass to 100 parts by mass of the base grease A. The base grease A to which the maleic acid-based additive had been added was mixed using a planetary centrifugal mixer under conditions that the rotation speed was 2000 rpm and the time was 3 minutes, and then homogenized using a triple roll mill to obtain a grease composition.

### Example 3

The maleic acid-based additive was added at 0.3 parts by mass to 100 parts by mass of the base grease A. The base grease A to which the maleic acid-based additive had been added was mixed using a planetary centrifugal mixer under conditions that the rotation speed was 2000 rpm and the time was 3 minutes, and then homogenized using a triple roll mill to obtain a grease composition.

### Example 4

The maleic acid-based additive was added at 0.1 parts by mass to 100 parts by mass of the base grease A. The base grease A to which the maleic acid-based additive had been added was mixed using a planetary centrifugal mixer under conditions that the rotation speed was 2000 rpm and the time was 3 minutes, and then homogenized using a triple roll mill to obtain a grease composition.

### Comparative Example 1

The base grease A was homogenized using a triple roll mill to obtain a grease composition of Comparative Example 1.

### Comparative Example 2

The maleic acid-based additive was added at 10 parts by mass to 100 parts by mass of the base grease A. The base grease A to which the maleic acid-based additive had been added was mixed using a planetary centrifugal mixer under conditions that the rotation speed was 2000 rpm and the time was 3 minutes, and then homogenized using a triple roll mill to obtain a grease composition.

### Example 5

The maleic acid-based additive was added at 5 parts by mass to 100 parts by mass of the base grease B. The base grease B to which the maleic acid-based additive had been added was mixed using a planetary centrifugal mixer under conditions that the rotation speed was 2000 rpm and the time was 3 minutes, and then homogenized using a triple roll mill to obtain a grease composition.

### Example 6

The maleic acid-based additive was added at 1 part by mass to 100 parts by mass of the base grease B. The base grease B to which the maleic acid-based additive had been added was mixed using a planetary centrifugal mixer under conditions that the rotation speed was 2000 rpm and the time was 3 minutes, and then homogenized using a triple roll mill to obtain a grease composition.

### Example 7

The maleic acid-based additive was added at 0.1 parts by mass to 100 parts by mass of the base grease B. The base grease B to which the maleic acid-based additive had been added was mixed using a planetary centrifugal mixer under conditions that the rotation speed was 2000 rpm and the time was 3 minutes, and then homogenized using a triple roll mill to obtain a grease composition.

### Comparative Example 3

The base grease B was homogenized using a triple roll mill to obtain a grease composition of Comparative Example 3.

### Comparative Example 4

The maleic acid-based additive was added at 10 parts by mass to 100 parts by mass of the base grease B. The base grease B to which the maleic acid-based additive had been added was mixed using a planetary centrifugal mixer under conditions that the rotation speed was 2000 rpm and the time was 3 minutes, and then homogenized using a triple roll mill to obtain a grease composition.

### (Evaluation of Grease Compositions)

The grease compositions prepared as Examples 1 to 7 and Comparative Examples 1 to 4 were evaluated. The evaluation items are measurement of worked penetration and measurement of bearing lubrication life.

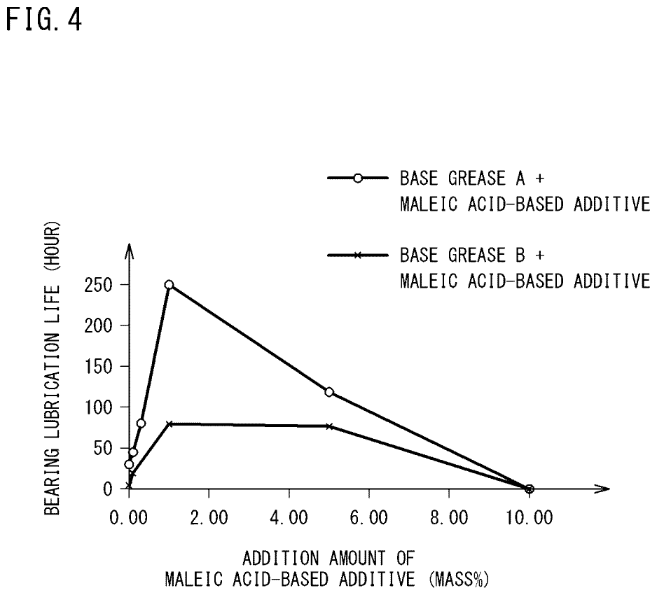

The results are shown in Tables 1 and 2 and FIG. 4. FIG. 4 is a graph obtained by plotting the relationship between the content of the maleic acid-based additive and the bearing lubrication life.

TABLE 1

| | | Example | Example | Example | Example | Comparative | Comparative |
|---|---|---|---|---|---|---|---|
| | | 1 | 2 | 3 | 4 | Example 1 | Example 2 |
| Thickener raw | 4,4′-MDI | 50 | 50 | 50 | 50 | 50 | 50 |
| material | Octadecylamine | 60 | 60 | 60 | 60 | 60 | 60 |
| (molar ratio) | Cyclohexylamine | 40 | 40 | 40 | 40 | 40 | 40 |
| | p-Toluidine | — | — | — | — | — | — |
| Base oil | Poly-α-olefin | 80 | 80 | 80 | 80 | 80 | 80 |
| (mass ratio) | Ester oil | 20 | 20 | 20 | 20 | 20 | 20 |
| | Ether oil | — | — | — | — | — | — |

| | | | | | | |
|---|---|---|---|---|---|---|
| Base oil kinematic viscosity | 42 | 42 | 42 | 42 | 42 | 42 |
| at 40° C. (mm²/s) | | | | | | |
| Thickener content (mass %) | 15 | 15 | 15 | 15 | 15 | 15 |
| Base oil content (mass %) | 85 | 85 | 85 | 85 | 85 | 85 |
| Maleic acid-based additive | 5 | 1 | 0.3 | 0.1 | — | 10 |
| content (mass %) | | | | | | |
| Worked penetration | 240 | 245 | 240 | 245 | 245 | 235 |
| Bearing lubrication life (hour) | 120 | 250 | 80 | 45 | 30 | Poor |
| | | | | | | rotation |

TABLE 2

| | | | | | Comparative | Comparative |
|---|---|---|---|---|---|---|
| | | Example 5 | Example 6 | Example 7 | Example 3 | Example 4 |
| Thickener raw | 4,4′-MDI | 50 | 50 | 50 | 50 | 50 |
| material | Octadecylamine | — | — | — | — | — |
| (molar ratio) | Cyclohexylamine | 70 | 70 | 70 | 70 | 70 |
| | p-Toluidine | 30 | 30 | 30 | 30 | 30 |
| Base oil | Poly-α-olefin | — | — | — | — | — |
| (mass ratio) | Ester oil | — | — | — | — | — |
| | Ether oil | 100 | 100 | 100 | 100 | 100 |

| | | | | | |
|---|---|---|---|---|---|
| Base oil kinematic viscosity | 100 | 100 | 100 | 100 | 100 |
| at 40° C. (mm²/s) | | | | | |
| Thickener content (mass %) | 15 | 15 | 15 | 15 | 15 |
| Base oil content (mass %) | 85 | 85 | 85 | 85 | 85 |
| Maleic acid-based additive content | 5 | 1 | 0.1 | — | 10 |
| (mass %) | | | | | |
| Worked penetration | 215 | 220 | 220 | 220 | 205 |
| Bearing lubrication life (hour) | 77 | 79 | 20 | 5 | Poor |
| | | | | | rotation |

The evaluation methods are as follows.

### (1) Worked Penetration

The worked penetrations (60W) of the grease compositions of the examples and the comparative examples were measured by a method conforming to JIS K 2220-7.

### (2) Bearing Lubrication Life

The grease compositions of the examples and the comparative examples were evaluated for bearing lubrication life.

The evaluation item for the bearing lubrication life is the time until the cage of the rolling bearing is damaged.

The bearing lubrication life test used to evaluate the bearing lubrication life is conducted using an air turbine test machine.

The test bearing is 3NC 608-2RU that is a deep groove ball bearing in which a plurality of balls is made of silicon nitride, an inner ring and an outer ring are made of JIS SUJ2 subjected to quenching and tempering, and seals are attached to the outer ring on both axial sides of the plurality of balls such that the seals do not come into contact with the inner ring.

The test temperature is room temperature (natural temperature rise), the rotation speed is 100000 min⁻¹, and the axial load is 20 N.

The grease composition filled the test bearing such that its volume was 20 vol % of the volume of a space surrounded by the inner ring, the outer ring, and the two seals, excluding the total volume of all the balls and the volume of the cage.

The poor rotation is a state in which the test bearing is unable to rotate smoothly due to the grease composition that fills the test bearing.

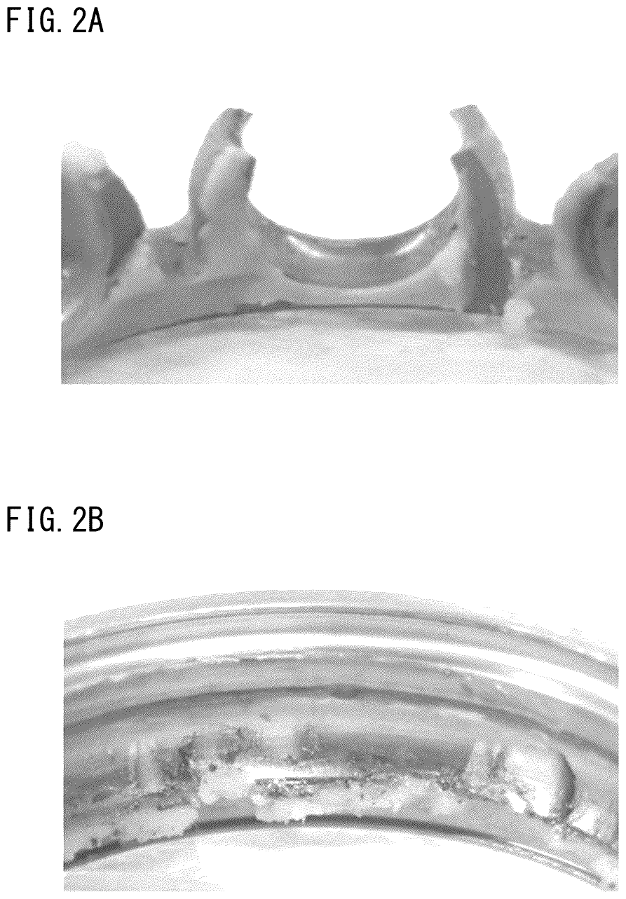

FIGS. 2(a) and 2(b) are photographs showing the state of an evaluation sample after 120 hours in a bearing lubrication life evaluation test conducted using the grease composition of Example 1. FIG. 2(a) is a photograph of a portion of the cage, and FIG. 2(b) is a photograph of a portion of the outer ring.

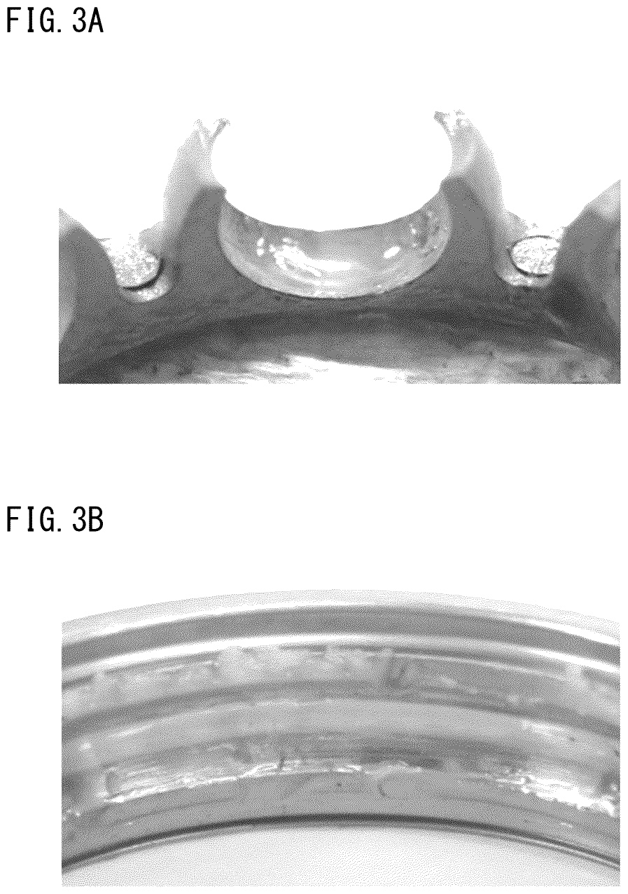

FIGS. 3(a) and 3(b) are photographs showing the state of an evaluation sample after 30 hours in a bearing lubrication life evaluation test conducted using the grease composition of Comparative Example 1. FIG. 3(a) is a photograph of a portion of the cage, and FIG. 3(b) is a photograph of a portion of the outer ring.

The evaluation of the bearing lubrication life demonstrates that the use of the grease composition according to the embodiment of the present disclosure can ensure a long bearing lubrication life even under high temperature and high speed conditions. FIGS. 2 and 3 demonstrate that the grease composition containing the maleic acid-based additive can easily maintain its adhesion to the cage and the raceway surface of the outer ring compared to the grease composition that does not contain the maleic acid-based additive.

### DESCRIPTION OF THE REFERENCE NUMERALS

1: deep groove ball bearing, 2: inner ring, 3: outer ring, 4: ball, 5: cage, 6: seal, 7: region, G: grease

1. A grease composition comprising base oil, a thickener, and a maleic acid-based additive, wherein
the maleic acid-based additive is a polymer including maleic anhydride and either or both of an acrylic acid derivative and an olefin as monomer components, and
a content of the maleic acid-based additive is 0.10 mass % or more and 8.10 mass % or less with respect to a total mass of the thickener and the base oil.

2. The grease composition according to claim 1, wherein the content of the maleic acid-based additive is 0.19 mass % or more and 7.50 mass % or less with respect to the total mass of the thickener and the base oil.

3. The grease composition according to claim 1, wherein the content of the maleic acid-based additive is 0.35 mass % or more and 6.20 mass % or less with respect to the total mass of the thickener and the base oil.

4. The grease composition according to claim 1, wherein the content of the maleic acid-based additive is 0.47 mass % or more and 5.00 mass % or less with respect to the total mass of the thickener and the base oil.

5. The grease composition according to claim 1, wherein a content of the thickener is 10.0 mass % or more and 20.0 mass % or less with respect to the total mass of the base oil and the thickener.

6. The grease composition according to claim 1, wherein the thickener is diurea.

7. The grease composition according to claim 1, wherein the base oil includes at least one of poly-α-olefin oil, ester oil, and alkyldiphenyl ether oil.

8. A rolling bearing comprising rolling elements, a first raceway member, a second raceway member, and grease, wherein
the grease includes the grease composition according to claim 1,
the first raceway member includes a first raceway,
the second raceway member includes a second raceway, and
the grease is interposed between the rolling elements and the first raceway and between the rolling elements and the second raceway, and adheres to at least one of a portion of the first raceway member adjacent to the first raceway and a portion of the second raceway member adjacent to the second raceway.

9. The rolling bearing according to claim 8, wherein
the first raceway member is an inner ring and the second raceway member is an outer ring, or
the first raceway member is a shaft washer and the second raceway member is a housing washer.

10. The rolling bearing according to claim 8, further comprising at least one member out of a cage and a sealing device, wherein the grease adheres to the member.

11. A maleic acid-based additive for use in a grease composition for a rolling bearing, the maleic acid-based additive comprising a polymer including maleic anhydride and either or both of an acrylic acid derivative and an olefin as monomer components.
